(19) United States
(12) Patent Application Publication
(10) Pub. No.: US 2006/0242041 A1
(43) Pub. Date: Oct. 26, 2006

(54) Method and financing system for funding a personal account

(76) Inventor: Michael L. Canney, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/110,522

(22) Filed: Apr. 20, 2005

(51) Int. Cl. G06Q 40/00

(52) U.S. Cl. 705/35

(57) ABSTRACT

A method of funding a personal savings account is accomplished by a donor selecting a personal account to be funded, the donor using a financial instrument which generates an embedded fee or an awards or loyalty program, and directing a portion of the embedded fee or awards program into the donor-designated account. A sub-account is established in the financial instrument for receipt of all or a portion of the fee or program value before disbursement into the savings account. Additional portions of the embedded fee or awards programs may be directed to a liaison, advisor, and/or administrator. A personal savings account may be a health account, retirement account, education account, or charitable account for the benefit and/or use of the donor or a third party. A method of systematically linking investing with directing of funds from the investment by designing a fee structure within the investment whereby part of the fee is credited into a sub-account.

### BACKGROUND OF THE INVENTION

1. Field of the Invention

The present invention relates to a method of receiving a portion of the account imbedded fee awards/loyalty program into a sub-account, investing this sub-account and directing from a sub-account inside a financial instrument and allowing to direct monetary disbursement from their sub-account into one or more specialized savings accounts.

2. Problems in the Art

Today we have seen tremendous growth in the need and usage of specialized savings accounts of various types, both taxable and non-taxable, i.e., 529 College Savings Plans, Health Savings and Medical Savings Accounts, IRA's, 403(B), 401(K), Keogh and now discussion of personal savings accounts within our nation's social security system, in addition to those specialized donor advised accounts within different types of 501(c)(3) organizations. Tax deductibility of moneys given to 501(c)(3)'s from the card owner's sub-account is another issue. Prior art forms never cared about the card owner and tax deductibility to them for these cash transfers.

Today we have also seen tremendous turmoil amongst many financial institutions regarding receipt of kickbacks, bid rigging, unknown and unauthorized rebates of commissions and the like, particularly in the Mutual Fund and Insurance industry, creating both perceived and real conflicts of interest.

Various types of personal savings accounts have become popular in recent years, such as health savings accounts, retirement accounts, and education accounts. Typically, such personal accounts are funded through contributions directly from the owner of the account, often times through payroll deductions. Thus, contributions to such accounts are made by reducing the owner's take-home pay or other income. Such a reduction in take-home pay or income is not a financial option for some people, and therefore they forego personal savings accounts or the full benefits that such accounts can provide if adequately or properly funded. For example, some types of personal savings accounts have beneficial tax consequences. Accounts can also be established for the benefit of others.

Imbedded fees come from two general sources. These two include the spread between what an issuing and/or merchant bank and/or card administrator (or other financial institutions) receives from the card user and what is paid to the merchant or vendor. The other avenue of imbedded fee comes from a rebate of a portion of the purchase price of merchandise/service from the merchant, manufactures, vendor or the like credited back to the card user for specific purchases and/or store purchases at merchant/vendor web site or store front, through the issuing bank and a card administrator. Versions of these two today often give rise to such verbiage as awards, points, rewards, loyalty and the like. Often times the points have a time limit, after which they expire and are no longer usable by the card holder. Also, the awards which can be purchased or acquired by converting the points typically are overstocked or outdated products.

Therefore, a primary objective of the present invention is the provision of an improved method for a donor to fund a personal savings account.

A further objective of the present invention is the establishment of a sub-account within a primary account having an imbedded fee, award, points and/or loyalty program, to allow an investor to direct money from the sub-account into specialized savings accounts.

Another objective of the present invention is the structure of sub-accounts imbedded within the primary account that will address many of the various governmental agencies concerns as well as the government concern of asset re-characterization for a portion of the account and the initiation of prohibited transactions, particularly as this could apply to investments for a participant's assets held within an ERISA plan.

Still another objective of the present invention is the structure of a sub-account imbedded within a credit/debit/ATM card that will also address the very important issue of whose money it is, particularly, if related monies are directed from the card directly into a 501(c)(3) donor advised account.

Another objective of the present invention is the provision of a method for funding a personal savings account through the use of a financial instrument which generates an embedded fee.

Another objective of the present invention is the provision of a method for funding a personal savings account through the use of a financial instrument having a program, such as awards, points or loyalty programs, with a monetary value.

Another objective of the present invention is the provision of a method for a donor to fund a personal account owned by another person or for the benefit of another person.

Yet another objective of the present invention is the provision of a financing system having a personal savings account funded through a financial instrument wherein a portion of a reserve value generated by the donor's use of the instrument is directed to the personal savings account.

Another objective of the present invention is the provision of a financial instrument having a sub-account which offers various benefits to the account owner/holder, as well as investment earnings opportunities for the account owner/holder.

A further objective of the present invention is the provision a primary financial account having a sub-account which earns interest for the account holder.

Another objective of the present invention is the provision of a financial instrument having a sub-account which accumulates points which can be converted into awards for the account holder.

Still another objective of the present invention is the provision of a financial instrument having a sub-account which accumulates non-expiring points for the benefit of the account holder.

Another objective of the present invention is the provision of a financing system for building the value of a personal savings account which does not have adverse tax consequences for the account owner.

These and other objectives will become apparent from the following description of the invention.

### SUMMARY OF THE INVENTION

The present invention is directed towards a method for a donor to fund a personal savings account through use of a financial instrument. In one embodiment, the donor's use of the financial instrument generates an embedded fee, and a portion of the fee is given to a sub-account from which the investor/donor may direct money to selected personal savings accounts.

In another embodiment, the donor's use of the financial instrument generates an awards, points or loyalty program with a monetary or reserve value to the donor, and a portion of the monetary value is directed to the sub-account, after which the investor/donor can direct money for funding a personal savings account.

The sub-account will also allow the rebate monies to accrue to the benefit of the card owner and to be invested in this embedded sub-account inside the card account, rather than be calculated as “points” or held in escrow by the card issuer. Points and escrow accounts currently earn money for the card administrator and card issuer's bank, but earn nothing for the card owner. It is only upon redemption or periodic transfer of said funds into an outside account that money is invested under prior art systems.

From this sub-account structure, both inside an investment/investment account and credit/debit/ATM account etc., the investor will be able to direct investments inside the sub-account. Investments in the sub-account may or may not mirror investments in the account (part of a sub-account, if applicable). The investor from the sub-account will be able to, at the time of account set up or at a later date, establish a link with one or more outside specialized savings accounts. The investor may then initiate fund transfers to these accounts where upon they may also direct investments inside these now linked specialized savings accounts. These specialized savings accounts may or may not provide a direct or indirect benefit to the investor/card owner/user.

Distribution from these specialized savings accounts may be directed by means of written instructions, internet instruction, grant instruction, check or debit card, ATM or electronic transfer of funds, or other options that do not discriminate against a consumer who does not have computer or internet access. Also, all governmental laws, rules and regulations must be adhered to with regard to establishment of the accounts and communications.

The financing system of the present invention allows a donor to fund a personal account through a sub-account of a financial instrument having a user cost and a reserve value based upon a percentage of the user cost. The system includes a donor-selected personal savings account, with a portion of the reserve value being directed by the donor to the personal savings account from the sub-account, which is funded when the donor uses the financial instrument in a manner generating the reserve value. The reserve value may be an embedded fee, an awards or points program, a loyalty program, or any other rebate program.

### BRIEF DESCRIPTION OF THE DRAWINGS

FIG. 1 is a flow chart of the method of funding a personal account according to one embodiment of the present invention.

FIG. 2 is a flow chart showing an example of a personal account funded by a portion of an embedded fee from a credit or debit card.

FIG. 3 is a flow chart showing another example of the funding of a personal account from an awards program of a credit or debit card.

FIG. 4 is a flow chart showing another embodiment of the present invention.

### DETAILED DESCRIPTION OF THE PREFERRED EMBODIMENTS

The present invention allows a donor to easily and automatically contribute to a personal savings account through the embedded fees and/or award programs commonly found in various financial instruments. The personal savings account or accounts may be owned by or for the benefit of the donor or another person, such as a relative. The personal accounts may take various forms, such as a health savings account, a retirement savings account, or an education savings account. The financial instruments from which the funding derives include credit cards, debit cards, mutual funds, annuities, life insurance, unit trusts, brokerage accounts, casualty insurance, CD's, mortgages, funds of various types, trust accounts, and the like which generate an imbedded fee or an awards/loyalty program. A sub-account in the financial instrument receives a portion of the imbedded fee or program value, and then the donor/investor can direct monetary disbursements from the sub-account to one or more savings accounts.

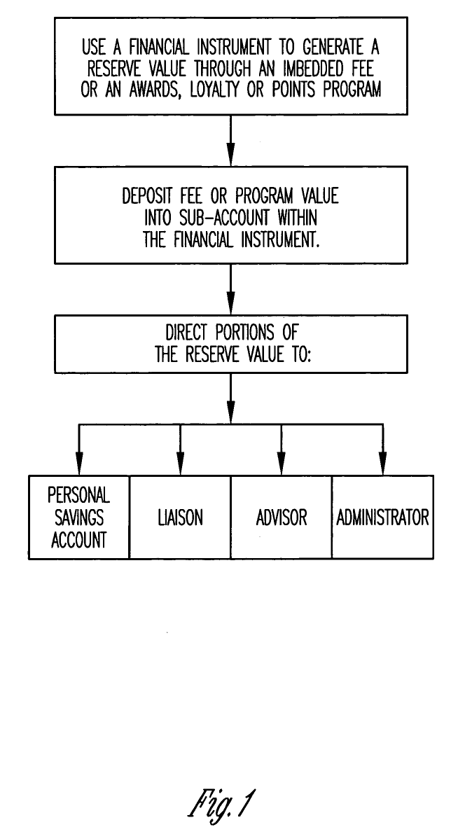

Once the personal savings account is established by the donor or the third party, contributions can be automatically made to the savings account from the sub-account each time the donor uses the financial instrument. As shown in FIG. 1, use of the financial instrument generates an embedded fee or an awards or loyalty program, both of which define a reserve value to the issuer of the financial instrument or the holder of the financial instrument, respectively. For example, when a consumer makes a purchase with a credit or debit card, the card issuing company pays the vendor 96% of the customer charge, and retains 4% as its fee. Many credit card companies use a portion of their embedded fee for an awards program which provides points rebates to the card holder. Such promotions are intended to attract new customers and retain existing customers. The card holder can then periodically use the points of the awards program to purchase merchandise or receives a check for the rebate value.

The method of funding a personal savings account involves the use of a financial instrument or a financial account with a sub-account imbedded in it. This financial instrument or financial account has an imbedded fee structure. For example, one such financial instrument is a mutual fund which typically charges an annual fee (expense ratio) based on assets invested, a portion of which is deducted from the investment daily. This fee typically is for investment management and various administrative costs. Other examples would include unit trusts, life insurance policies, annuities, casualty insurance policies, brokerage accounts, CD's, mortgages, funds transfers, trust accounts, among others. From the fees that are normally deducted from this value of/or earnings and the investment instrument, account or service, a portion would be re-directed into the sub-account, (inside the financial instrument, financial account or financial service) over which the investor, account owner/beneficiary may direct investment in the account and sub-account. The investor may then also, if appropriate, add monies from the account or from a bank account-credit/debit card-ATM transaction smart or gift card into the sub-account.

The investor may direct monies then from the sub-account into one or more specialized personal savings accounts. These personal savings accounts may be for the benefit of the investor or for the benefit of another individual or entity. Examples of such savings accounts, but not limited to such accounts, included: health savings/medical savings accounts, personal savings accounts, 529 college savings accounts, individual retirement savings accounts (IRA's, ROTH IRA's, KEOGH Accounts, 403(B), 457, trust accounts, custodial accounts, retirement savings accounts proposed inside and under the Social Security Administration), charitable accounts (which may be 501(c)(3) organizations), as well as accounts within other non-tax exempt organizations.

The investor/contributor/donor, if allowed by law, may then be able to direct investments within any of the above (but not limited to) specialized savings accounts. This includes all investing/reallocation, etc., allowable by the SEC under the law. Note, although internet direction is the preferred implementation of the embodiment it is important to comply with all law so as not to discriminate in favor of certain classes of investors/consumers-particularly regarding ERISA Accounts. The investor/contributor/donor may then direct disbursements (grant requests in the case of a 501(c)(3) account/organization) from this specialized savings account, as allowed.

Disbursement from this account may be in the form of verbal, written, electronic, or internet instruction given to an account servicing agent, and may be through check, electronic funds transfer, ATM, or debit card attached directly to this specialized savings account. Further steps include introducing the investor to this sub-account and directed personal savings account method, and advising the investor with regard to investment of the financial instrument, financial account or financial service, and investment of its sub-account. A non-advisor liaison and advisor would receive compensation from specific parts of the standard fee. A portion of this fee may also cover other elements of administration.

A second embodiment involves a purchasing account such as a credit/debit card, smart card, ATM card, gift card, electronic fund transfer, and the like.

Card enrollment may be through written application, telephone, computer, internet or any other legal acceptable means. Consumer transactions covered include, but are not limited to, point of sale transactions, on-line/off-line e-commerce, internet, and any other to be conceived legal way to purchase goods/services.

The leverage is in the flow of money into the sub-account from a portion of the imbedded fee included in all card transactions. Under the present invention, a portion of this imbedded fee from portions of one or both of the above described imbedded fees from or “card”/electronic funds transfer will be directed into the sub-account (inside the financial instrument). Other parts of the fee may be used to compensate the consumer advisor, if any, and to compensate the non-advisor, liaison/administrator.

Rather than a credit/debit card, the account could be a brokerage account, trust account or any other account a financial service to which a fee is applied. Part of the fee is directed to the sub-account, while other parts of the fee can be used to compensate the investor's investment advisor and the non-advisor liaison.

Under the present invention, rather than providing points or rebates to the card holder, all or a portion of the points or rebates from the award/loyalty program are deposited into the sub-account, from which the card holder may direct disbursements to one or more designated personal savings accounts. As a further incentive to attract new customers and retain existing customers, the card issuer can also allow the card holder to direct a portion of the embedded fee to one or more personal savings accounts, as designated by the card holder/donor. Under both embodiments, the card issuer preferably retains the same net profit from their embedded fee, since the promotional expenses related to the embedded fee are merely being directed, in whole or in part, to the savings accounts selected by the card holding donor.

As shown in FIG. 1, the portion of the embedded fee or awards program may be directed to entities in addition to the personal savings accounts designated by the donor. For example, a liaison who introduces the potential donor to this account funding system may receive a small fee for such a referral. A financial advisor may also be a part of the system, and may provide legal and/or tax advice to the donor, in return for a small portion of the reserve value of the financial instrument. The administrator of the personal account funding system may also receive a small portion of the reserve value generated by the use of the financial instrument.

In addition to credit and debit cards, the system and method of the present invention can be used with other types of financial instruments. For example, a brokerage account that charges a fee or commission to the user can dissect the fee such that a portion is directed to the user/donor's designated personal savings account. Other parts of the fee or commission can be used to compensate the liaison, advisor, and/or administrator.

Similarly, the method and system of the present invention can be used with other financial instruments such as life insurance or annuities which typically have a built-in fee charged to the owner of the instrument. A portion of the insurance or annuity fee can be directed to one or more personal savings accounts, as designated by the owner/donor as well as to a liaison, advisor, and/or administrator.

The system and method of funding the personal savings accounts can be implemented in several ways, including through the Internet, through telephones, or through hard copy fax or mail. Enrollment in the account funding system can thus be done on-line, on the phone, or through written application. Contributions will be automatically made to the donor's designated accounts each time the financial instrument is used, such as purchases with a credit or debit card made on-line, at the point of sale, or through the telephone. Other cards, such as an ATM card, Smart Card, and gift card which have associated fees or awards may also be utilized to contribute to the personal savings accounts. Also, the personal savings accounts can be changed at the request of the donor using the Internet, telephone, or written applications.

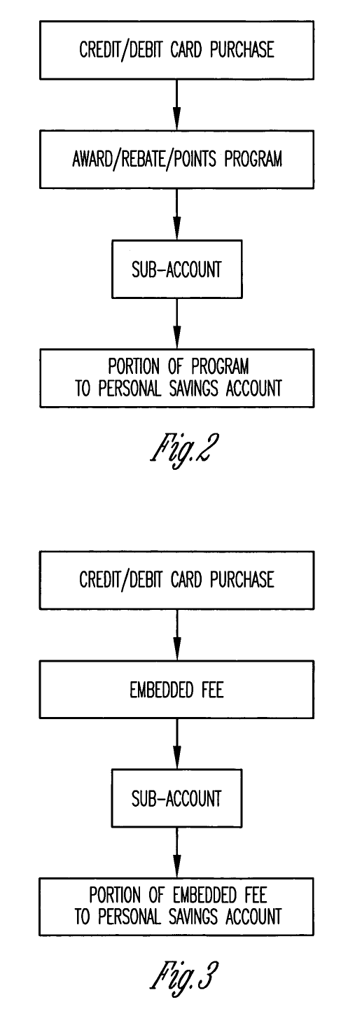

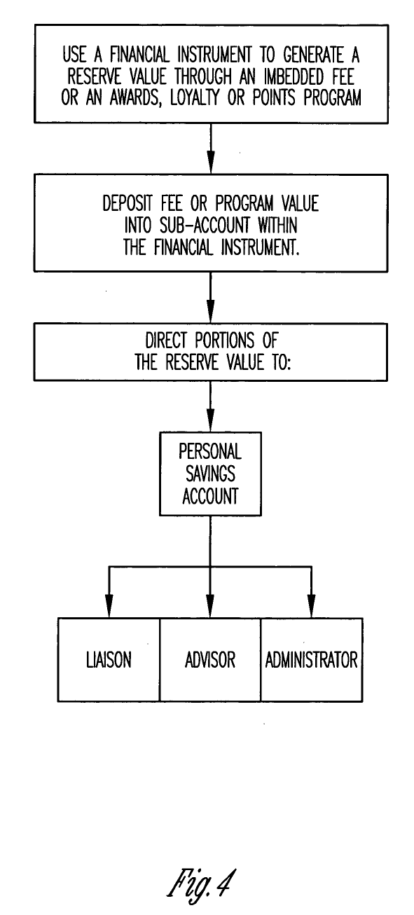

FIGS. 2 and 3 show simplified transactions for funding a personal savings account according to the present invention. In FIG. 2, a credit or debit card is used to make a purchase, which in turn generates an award or rebate or points program. A portion of the program is then directed to the personal savings account, either directly or through a sub-account. In FIG. 3, the credit or debit card holder uses the card to make a purchase, which generates an embedded fee, with a portion of the embedded fee being directed to one or more personal savings accounts, directly or through the sub-account. It is understood that the sub-account may be required in some instances, but not all, due to tax reasons, such as IRS regulations.

This sub-accounts investment structure and/or the savings account investment structure may imbed the advisor/non-advisor liaison structure while other portions of the fee may pay the fund manager and/or administration costs associated with the administration of the account and its sub-account. As seen in FIG. 1, the liaison, advisor and/or administrator receive their fees from the sub-account. In comparison, FIG. 4 shows their fees coming from the savings account.

The investor will be able to direct investments of the primary and sub-account. Investments may or may not be of similar nature in the primary and sub-account. The investor may then direct from the sub-account money transfers into a specified account or accounts. These specified accounts may be in existence already or opened later on. The investor may then be able to direct investments inside this specified account/accounts and direct distribution from the specified account checks or debit cards are used for its specified purposes.

Investors may be introduced to this investment through many different venues, such as financial advisors/institutions financial planners, CPA's, attorneys, organizations, business, merchants, or even municipalities and government. Part of the fee associate with the investment will go to non-advisor liaisons for their function/responsibilities benefit in the investor in the non-advisory roles they perform for the benefit of the investor. A portion of the fee also associated with the investment will go to the advisor. If the form of investment is a mutual fund, then the fund manager will also be compensated from a part of the fee. In an alternative method, a credit card or debit card, ATM, smart card and the like may also be utilized to systematically link the sub-account within the card account. This sub-account receives portions of imbedded fees and rebates from card administrators, card issuing banks, merchant banks and merchants.

The card owner directs investments offered in this sub-account and then may direct from this sub-account money transfers into a specified savings account or accounts. The card owner may then be able to direct investments in this specified account/accounts and direct distributions from the specified account.

It is understood that the sub-account may not be necessary, depending on laws and regulations. In such cases, a portion or all of the imbedded fee or program value may be directed to the savings account by the donor/investor without first directing or depositing the fee or value to a sub-account.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method for a donor to fund a personal savings account, comprising:
the donor selecting a personal savings account to be funded;
the donor using a financial instrument which generates an imbedded fee;
establishing a sub-account within the financial instrument to receive all or a portion of the imbedded fee; and
directing a portion of the imbedded fee from the sub-account to the personal savings account.

2. The method of claim 1 wherein the savings account is selected from a health savings account, a medical savings account, a retirement account, an education account, a trust account, a personal investment account, a personal brokerage account, a personal checking account, a certificate of deposit, a mortgage payment account, and a charitable account.

3. The method of claim 1 wherein the financial instrument is selected from a credit card, a debit card, a mutual fund, an annuity, a unit trust, a brokerage account, a trust account, a life insurance policy, a casualty insurance policy, a brokerage account, a CD, and a mortgage account.

4. The method of claim 1 wherein the donor owns the personal savings account.

5. The method of claim 1 wherein the donor does not own the personal savings account.

6. The method of claim 1 wherein the personal account is non-charitable.

7. The method of claim 1 further comprising introducing the donor to the account funding process, and compensating whomever introduced the donor to the funding method with a second part of the fee.

8. The method of claim 1 further comprising advising the donor of the benefits of the personal account and compensating whomever provides the advice with a third portion of the fee.

9. The method of claim 1 wherein the personal account is for the benefit of an entity other than the donor.

10. The method of claim 1 wherein an entity selected from a liaison, advisor, and administrator receives a fee from one of the sub-account and savings account.

11. A method for a donor to fund a personal savings account, comprising:
the donor selecting a personal savings account to be funded;
the donor using a financial instrument having an awards or loyalty program with a monetary value to the donor;
establishing a sub-account within the financial instrument to receive all or a portion of the program value; and
directing at least a portion of the monetary value from the sub-account to the personal savings account.

12. The method of claim 11 wherein the account is selected from a health savings account, a medical savings account, a retirement account, an education account, a trust account, a personal investment account, a personal brokerage account, a personal checking account, a certificate of deposit, a mortgage payment account, and a charitable account.

13. The method of claim 11 wherein the financial instrument is a credit card, a debit card, a mutual fund, an annuity, a unit trust, a brokerage account, a trust account, a life insurance policy, a casualty insurance policy, a brokerage account, a CD, and a mortgage account.

14. The method of claim 11 wherein the donor owns the personal savings account.

15. The method of claim 11 wherein the donor does not own the personal savings account.

16. The method of claim 11 wherein an entity selected from a liaison, advisor, and administrator receives a fee from one of the sub-account and savings account.

17. A financing system for a donor to fund a personal savings account, comprising:
a financial instrument having a user cost and reserve value based on a percentage of the cost;
a donor-selected personal savings account;
a sub-account within the financial instrument to receive all or a portion of the reserve value before receipt in the savings account; and
a portion of the reserve value being directed by the donor from the sub-account to the personal account when the donor uses the financial instrument in a manner generating the reserve value.

18. The financing system of claim 17 wherein the reserve value is an imbedded fee.

19. The financing system of claim 17 wherein the reserve value is points, reward, award or loyalty program.

20. The financing system of claim 17 wherein an entity selected from a liaison, advisor, and administrator receives a fee from one of the sub-account and savings account.
